(19) United States
(12) Patent Application Publication
(10) Pub. No.: US 2009/0102372 A1
(43) Pub. Date: Apr. 23, 2009

(54) DISPLAY DEVICE AND METHOD OF PRODUCING THE SAME

(75) Inventors: Kunio Kondo, Chiba (JP); Kanjiro Sako, Chiba (JP); Takeo Watanabe, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/300,293

(22) PCT Filed: May 9, 2007
(86) PCT No.: PCT/JP2007/059993

§ 371 Date: Nov. 10, 2008

(30) Foreign Application Priority Data
May 10, 2006 (JP) 2006-131532

(51) Int. Cl. H01J 1/63; H01J 9/24; H01J 9/00

(52) U.S. Cl. 313/504; 445/24; 445/46; 257/E21.002

(57) ABSTRACT

Disclosed is a display device displaying a predetermined pattern comprising an organic electroluminescence element comprising a transparent anode, an organic electroluminescent compound layer, a cathode buffer layer patterned predetermined pattern and a cathode insulating substrate. The display device can display a predetermined pattern with high electrical power efficiency by a simple structure.

### TECHNICAL FIELD

The present invention relates to a display device, more specifically, to a display device that uses an organic electroluminescence element (hereinafter, also called as “organic EL element”) and displays a predetermined pattern.

### BACKGROUND ART

As a display device that uses an EL element and displays a predetermined pattern, there have been known so far display devices employing a variety of systems.

For instance, Japanese Patent Laid-Open Publication No. 2001-331134 (Patent Document 1) discloses an electroluminescent display sheet having a transparent sheet that is printed so as to form a transparent portion having a predetermined pattern and is laminated on the luminous face of a whole surface-emitting EL element. The electroluminescent display sheet displays the predetermined pattern by transmitting the light emitted from an EL element to the outside only through the transparent portion having the predetermined pattern formed in the transparent sheet. However, the problem is that the electroluminescent display sheet has a low electric power efficiency, because a part of the light emitted from the EL element is blocked off by the printed portion of the transparent sheet.

Further, Japanese Patent Laid-Open Publication No. 2003-77664 (Patent Document 2) discloses a matrix-type organic EL display in which a specific sign pattern is formed in the vicinity of each EL element in a luminescence display area, at an interval of a given number of EL elements counted from the EL element positioned at the end or a reference point in the luminescence display area. In this organic EL display, by applying current to a specific anode line and a cathode line, a pixel positioned at an intersection point of these lines is lighted. A predetermined pattern is displayed by regulating the lighting of the pixels. However, the display has a complicated structure and requires a control device to display a predetermined pattern, so that there was a problem that the size and cost of the display device became large.

[Patent Document 1] Japanese Patent Laid-Open Publication No. 2001-331134

[Patent Document 2] Japanese Patent Laid-Open Publication No. 2003-77664

### DISCLOSURE OF THE INVENTION

It is an object of the present invention to provide a display device that uses an organic EL element and has a simple structure and a high electric power efficiency.

The present inventors have carried out intensive studies to address the above problems and have completed the present invention. The present invention directs to the following items (1) to (14):

(1) A display device that displays a predetermined pattern and has an organic electroluminescence element comprising a transparent anode, an organic electroluminescent compound layer, a cathode buffer layer patterned in an almost similar form to the predetermined pattern and a cathode laminated in this order on a transparent insulating substrate;

(2) The display device as described in (1), wherein the organic electroluminescent compound layer contains a phosphorescent compound;

(3) The display device as described in (2), wherein the phosphorescent compound is an iridium complex;

(4) The display device as described in (2) or (3), wherein the phosphorescent compound is a phosphorescent polymer compound;

(5) The display device as described in (4), wherein the phosphorescent polymer compound is a phosphorescent non-conjugated polymer compound;

(6) The display device as described in (5), wherein the phosphorescent non-conjugated polymer compound is a polymer compound having a structural unit derived from an iridium complex compound that is obtained by substituting a polymerizable substituent for one or more hydrogen atoms contained in a compound represented by the following formula (X-1);

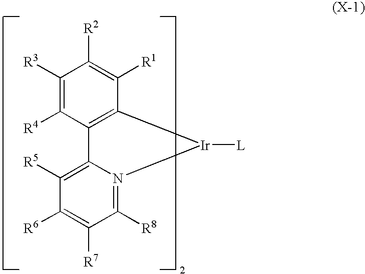

(In the formula (X-1), R¹ to R⁸ each represent independently an atom or a substituent selected from the group consisting of a hydrogen atom, a halogen atom, a cyano group, an alkyl group having from 1 to 10 carbon atoms, an aryl group having from 6 to 10 carbon atoms, an amino group optionally substituted with an alkyl group having from 1 to 10 carbon atoms, an alkoxy group having from 1 to 10 carbon atoms, and a silyl group; R¹ and R², R² and R³, R³ and R⁴, R⁴ and R⁵, R⁵ and R⁶, R⁶ and R⁷, or R⁷ and R⁸ may be bonded together to form a condensed ring; and L is a bidentate ligand selected from the group consisting of the following formulae (X-2) to (X-4).)

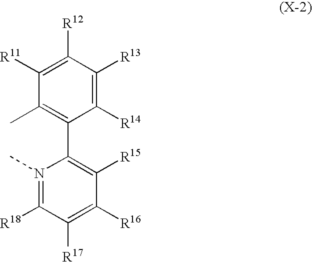

(In the formula (X-2), R¹¹ to R¹⁸ are the same as R¹ to R⁸ in the formula (X-1).)

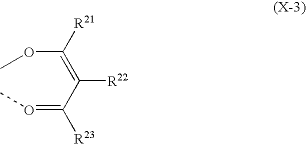

(In the formula (X-3), R²¹ to R²³ each represent independently an atom or a substituent selected from the group consisting of a hydrogen atom, a cyano group, an alkyl group having from 1 to 10 carbon atoms, an aryl group having from 6 to 10 carbon atoms, an amino group optionally substituted with an alkyl group having from 1 to 10 carbon atoms, an alkoxy group having from 1 to 10 carbon atoms, and a silyl group; and R²¹ and R²², or R²² and R²³ may be bonded together to form a condensed ring.)

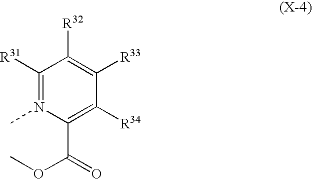

(In the formula (X-4), R³¹ to R³⁴ each represent independently an atom or a substituent selected from the group consisting of a hydrogen atom, a cyano group, an alkyl group having from 1 to 10 carbon atoms, an aryl group having from 6 to 10 carbon atoms, an amino group optionally substituted with an alkyl group having from 1 to 10 carbon atoms, an alkoxy group having from 1 to 10 carbon atoms, and a silyl group; and R³¹ and R³², R³² and R³³, or R³³ and R³⁴ may be bonded together and form a condensed ring.)

(7) The display device as described in (5), wherein the phosphorescent non-conjugated polymer compound is a polymer compound having a structural unit derived from an iridium complex compound that is obtained by substituting a polymerizable substituent for one or more hydrogen atoms contained in at least one kind of compound selected from the group consisting of compounds represented by the following formulae (E-2), (E-17), (E-32), and (E-33);

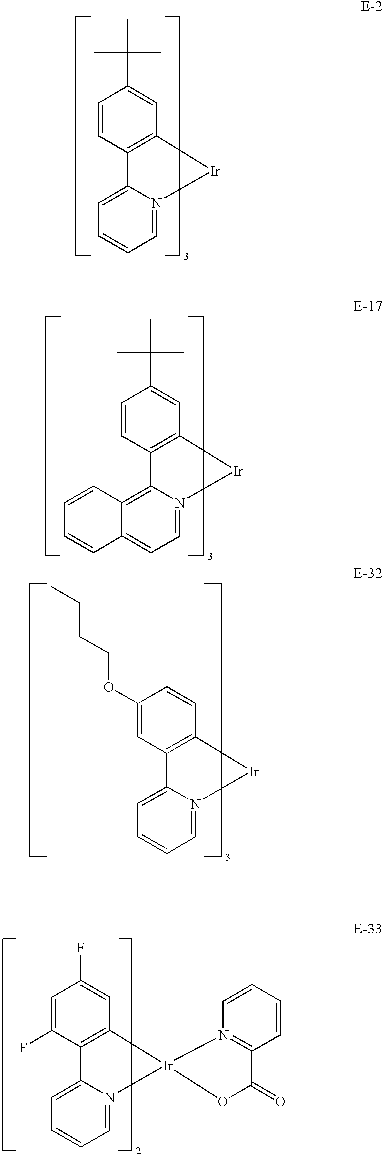

(8) A method of producing a display device ford is playing a predetermined pattern, comprising steps of:

forming a cathode buffer layer patterned in an almost similar form to the predetermined pattern on the surface of an organic electroluminescent compound layer; and

forming a cathode on the surface of the cathode buffer layer;

(9) The method of producing a display device as described in (8), comprising

in the step of forming the cathode buffer layer, depositing a material for forming the cathode buffer layer on the organic electroluminescent compound layer through a mask having an opening that is patterned in an almost similar form to the predetermined pattern, and

in the step of forming the cathode, subsequently forming the cathode after removing the mask;

(10) A cellular phone display screen comprising the display device as described in any of (1) to (7);

(11) A portable music player display screen comprising the display device as described in any one of (1) to (7);

(12) An in-vehicle rearview mirror comprising the display device as described in any one of (1) to (7);

(13) A mirror comprising the display device as described in any one of (1) to (7); and

(14) A display device for theaters comprising the display device as described in any one of (1) to (7).

### EFFECT OF THE INVENTION

The display device of the present invention can display a predetermined pattern with high electrical power efficiency by a simple structure.

### BRIEF DESCRIPTION OF THE DRAWINGS

FIG. 1 is a schematic cross-sectional view illustrating an exemplary embodiment of an organic EL element used in the present invention.

FIG. 2 shows an example of a patterned cathode buffer layer form.

FIG. 3 shows two kinds of masks used for forming the patterned cathode buffer layer shown in FIG. 2.

FIG. 4 shows the mask used in Example 1.

FIG. 5 shows the pattern of the cathode buffer layer formed in Example 1.

FIG. 6 is a schematic front view of the evacuation sign prepared in Example 1 on lighting (emitting light).

FIG. 7 shows the mask used for forming the cathode buffer layer in Example 2.

FIG. 8 shows the mask used for forming the cathode buffer layer in Example 2.

FIG. 9 shows the pattern of the cathode buffer layer formed in Example 2.

FIG. 10 is a schematic front view of the display device for theaters prepared in Example 2 on lighting (emitting light).

FIG. 11 is a schematic cross-sectional view of an exemplary embodiment of a conventional organic EL element having a cathode buffer layer.

1 transparent substrate
2 anode
3 organic EL compound layer
31 hole-transporting layer
32 light-emitting layer
33 electron-transporting layer
4 cathode buffer layer
5 cathode
6 mask
7 opening of mask
8 displayed predetermined pattern

### BEST MODE FOR CARRYING OUT THE INVENTION

The display device of the present invention will be described in more detail below.

### Organic EL Element

The display device of the present invention displays a predetermined pattern, and comprises an organic electroluminescent element, wherein a transparent anode, an organic electroluminescent compound layer, a cathode buffer layer patterned in an almost similar form to the predetermined pattern, and a cathode are laminated in this order on a transparent insulating substrate.

Note that, in the present description, the direction toward the transparent anode from the transparent insulating substrate composing the organic EL element is defined as “upper” for convenience.

### 1. Element Configuration

FIG. 1 is a cross-sectional view illustrating an exemplary configuration of the main part of an organic EL element (main element part) used in the present invention. On a transparent substrate 1, an anode 2, a hole-transporting layer 31, a light-emitting layer 32, an electron-transporting layer 33, a patterned cathode buffer layer 4, and a cathode 5 are formed in turn.

The configuration of the organic EL element used in the present invention is not limited to the exemplary configuration shown in FIG. 1. Examples of an element constitution of layers which are successively provided between the anode and the cathode include 1) an anode buffer layer/a hole-transporting layer/a light-emitting layer; 2) an anode buffer layer/a light-emitting layer/an electron-transporting layer; 3) an anode buffer layer/a hole-transporting layer/a light-emitting layer/an electron-transporting layer; 4) an anode buffer layer/a layer containing a hole-transporting compound, a light-emitting compound and an electron-transporting compound; 5) an anode buffer layer/a layer containing a hole-transporting compound and a light-emitting compound; 6) an anode buffer layer/a layer containing a light-emitting compound and an electron-transporting compound; 7) an anode buffer layer/a layer containing a hole electron-transporting compound and a light-emitting compound; or other configurations.

The light-emitting layer shown in FIG. 1 is a single layer, but two or more light-emitting layers may be provided.

Further, the layer containing a hole-transporting compound may directly contact the anode surface without involving the anode buffer layer.

Note that, in the present description, unless otherwise stated, all of the electron-transporting compound, hole-transporting compound and luminescent compound, and a compound that contains one or more kinds of these compounds are called an organic EL compound, and the layer comprising thereof is called an organic EL compound layer.

### 2. Anode

The anode is composed of an electroconductive and optically transparent layer as represented by ITO. The anode is required to have an optical transparency when the organic luminescence is viewed through the substrate. On the other hand, when the organic luminescence is viewed as a top emission through the upper electrode, the anode is not required to have an optical transparency. In this case, the anode may be made of any appropriate material having a work function of 4.1 eV or more such as a metal or a metal compound. For example, gold, nickel, manganese, iridium, molybdenum, palladium, platinum and the like may be used either singly or as combined.

The anode may be also made of a material selected from the group consisting of metal oxides, nitrides, selenides, and sulfides. Further, a thin film having the thickness of 1 to 3 nm of the metals may be formed on the surface of ITO having a good optical transparency and may serve as the anode as long as the optical transparency is not impaired. The thin film may be formed on the surface of the anode material by electron beam evaporation, sputtering, chemical reaction, coating, vacuum deposition, or other techniques. The thickness of the anode is preferably from 2 to 300 nm.

### 3. Anode Surface Treatment

The anode surface may be preliminary treated before the anode buffer layer or the layer containing a hole-transporting compound is formed, so that the performance (adhesion to the anode substrate, surface smoothness, reduction of the hole-injection barrier, and the like) of the layer to be coated over the anode may be improved. RF plasma treatment, sputtering, corona discharge, UV/ozone irradiation, oxygen plasma treatment, and the like may be used for the preliminary treatment.

### 4. Anode Buffer Layer: in the Case of Using “BAYTRON” and the Like

The anode buffer layer may be formed in a wet process using a coating method such as spin coating, casting, micro-gravure coating, gravure coating, bar coating, roll coating, wire-bar coating, dip coating, spray coating, screen printing, flexo printing, offset printing, ink-jet printing, and the like.

There is not any particular limitation on the compound used in the wet process as long as the compound has a good adhesion to the anode surface and the organic EL compound contained in the upper layer formed on the anode surface, but the conventional anode buffers so far used is preferably employed. For example, there may be mentioned an electroconductive polymer such as PEDOT-PSS that is a mixture of poly(3,4)-ethylenedioxythiophene and polystyrene sulfonate, PANI that is a mixture of polyaniline and polystyrene sulfonate, and the like. Further, these electroconductive polymers may be mixed with an organic solvent such as toluene and isopropyl alcohol. The electroconductive polymer may contain a third component such as a surfactant. Examples of the surfactant include a surfactant containing one kind of group selected from the group consisting of an alkyl group, an alkylaryl group, a fluoroalkyl group, an alkylsiloxane group, a sulfate, a sulfonate, a carboxylate, an amide, a betaine structure, and a quaternary ammonium group. A fluoride-based nonionic surfactant may be also used.

### 5. Organic EL Compound

As the compound used for the organic EL compound layer, that is, the light-emitting layer, hole-transporting layer, and electron-transporting layer in the organic EL element used in the present invention, any of a low-molecular-weight compound and a high-molecular-weight (polymer) compound may be used.

As the organic EL compound that forms the light-emitting layer of the organic EL element used in the present invention, there may be exemplified a luminescent low-molecular-weight compound and a luminescent high-molecular-weight (polymer) compound, both described in Applied Physics, Vol. 70, No. 12, pp 1419-1425 (2001) by Yutaka Ohmori. Among these, the luminescent polymer compound is preferable, because the process of producing the EL element can be simplified. In view of attaining high luminescence efficiency, a phosphorescent compound is preferable. Therefore, a phosphorescent polymer compound is particularly preferable.

The luminescent polymer compound may be also classified into a conjugated luminescent high-molecular-weight (polymer) compound and a non-conjugated luminescent high-molecular-weight (polymer) compound. The conjugated luminescent polymer compound is a polymer compound that has a conjugated structure over the entire main molecular chain (the longest bonded chain in the polymer compound structure) or substantially over the entire molecule. The non-conjugated luminescent polymer compound has a conjugated structure other than the foregoing conjugated structure.

In the steps of producing organic EL elements, the luminescent polymer compound may suffer from irreversible partial defects by photo-irradiation in the presence of oxygen, heating (for example at 100° C. or more), ultrasonic dispersion treatment, and the like that are applied to the component materials. In addition, the polymer compound has a terminal structure different from the other parts in general. Further, foreign impurities may be mixed into the polymer compound when the polymer compound is prepared, dissolved into a solution, or coated.

Since the conjugated structure of the conjugated luminescent polymer compound spreads over the entire molecule, the partial structural defects present in the molecule, the terminal structures, and the impurities contained in the component materials affect the conjugated structure of the whole molecule. Therefore, the properties of the conjugated luminescent polymer compound formed into an organic EL compound layer are easy to change, thereby possibly bringing about the lowering in the luminescence efficiency or durability of organic EL elements.

On the other hand, the non-conjugated luminescent polymer compound, as a whole molecule, suffers less from the aforementioned partial structural defects and the like, since the conjugated structure is isolated in each repeating unit.

Therefore, in view of providing an organic EL element having high luminescence efficiency and durability at a high reproducibility, it is preferable that the non-conjugated luminescent polymer compound is used for the material for forming the organic EL compound layer.

For the above reason, as a luminescence material used in the present invention, a phosphorescent non-conjugated polymer compound (a luminescence material that is the aforementioned phosphorescent polymer compound and is the aforementioned non-conjugated luminescent polymer compound) is particularly preferable.

The light-emitting layer of the organic EL element used in the present invention contains at least a phosphorescent polymer compound containing a phosphorescent unit, which emits phosphorescence, and a carrier-transporting unit in one molecule. The phosphorescent polymer compound is obtained by copolymerizing a phosphorescent compound having a polymerizable substituent and a carrier-transporting compound having a polymerizable substituent. The phosphorescent compound is a metal complex that contains a metal element selected from iridium, platinum, and gold. Among these metal complexes, an iridium complex is preferable, because the complex has a high luminescence efficiency and thus is excellent in energy saving property, and is capable of reproducing a wide range of colors by selecting a ligand.

Examples of the iridium complex include a compound that is obtained by substituting a polymerizable substituent for one or more hydrogen atoms contained in the compound represented by the following formula (X-1).

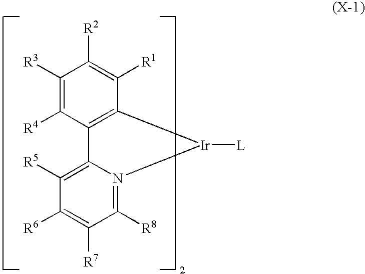

(In the formula (X-1), R¹ to R⁸ each represent independently an atom or a substituent selected from the group consisting of a hydrogen atom, a halogen atom, a cyano group, an alkyl group having from 1 to 10 carbon atoms, an aryl group having from 6 to 10 carbon atoms, an amino group optionally substituted with an alkyl group having from 1 to 10 carbon atoms, an alkoxy group having from 1 to 10 carbon atoms, and a silyl group; R¹ and R², R² and R³, R³ and R⁴, R⁴ and R⁵, R⁵ and R⁶, R⁶ and R⁷, or R⁷ and R⁸ may be bonded together to form a condensed ring; and L is a bidentate ligand selected from the group consisting of the following formulae (X-2) to (X-4).)

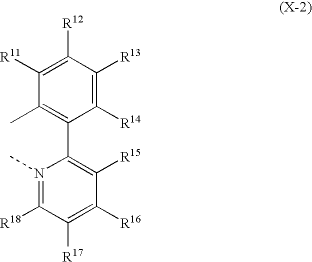

(In the formula (X-2), R¹¹ to R¹⁸ are the same as R¹ to R⁸ in the formula (X-1).)

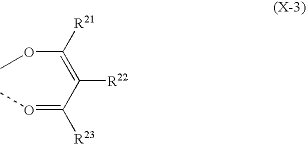

(In the formula (X-3), R²¹ to R²³ each represent independently an atom or a substituent selected from the group consisting of a hydrogen atom, a cyano group, an alkyl group having from 1 to 10 carbon atoms, an aryl group having from 6 to 10 carbon atoms, an amino group optionally substituted with an alkyl group having from 1 to 10 carbon atoms, an alkoxy group having from 1 to 10 carbon atoms, and a silyl group; and R²¹ and R²², or R²² and R²³ may be bonded together to form a condensed ring.)

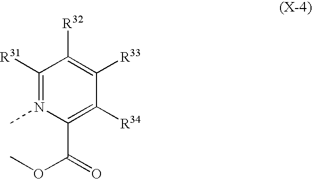

(In the formula (X-4), R³¹ to R³⁴ each represent independently an atom or a substituent selected from the group consisting of a hydrogen atom, a cyano group, an alkyl group having from 1 to 10 carbon atoms, an aryl group having from 6 to 10 carbon atoms, an amino group optionally substituted with an alkyl group having from 1 to 10 carbon atoms, an alkoxy group having from 1 to 10 carbon atoms, and a silyl group; and R³¹ and R³², R³² and R³³, or R³³ and R³⁴ may be bonded together and form a condensed ring.)

Examples of the phosphorescent compound having the polymerizable substituent include, more specifically, for example, a compound that is obtained by substituting a polymerizable substituent for one or more hydrogen atoms contained in the metal complex represented by the following formulae (E-1) to (E-49).

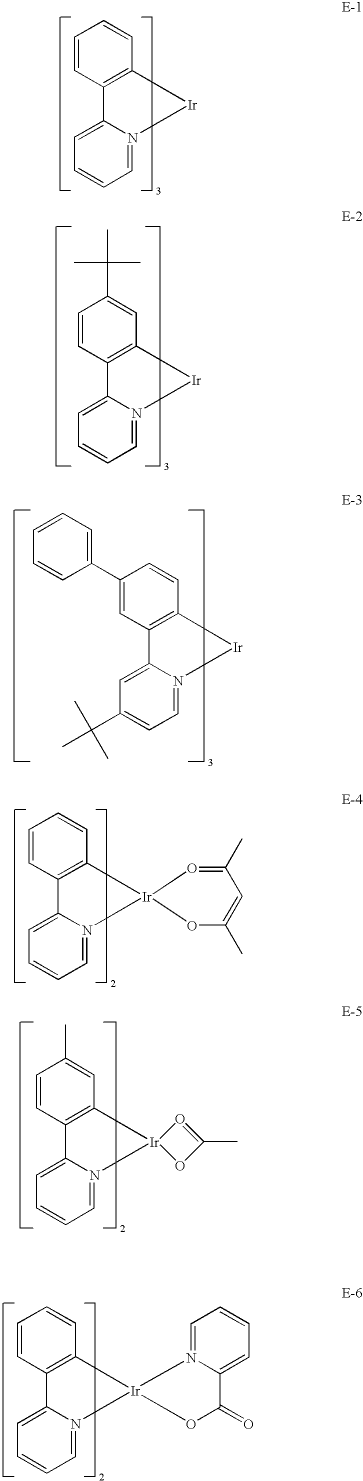

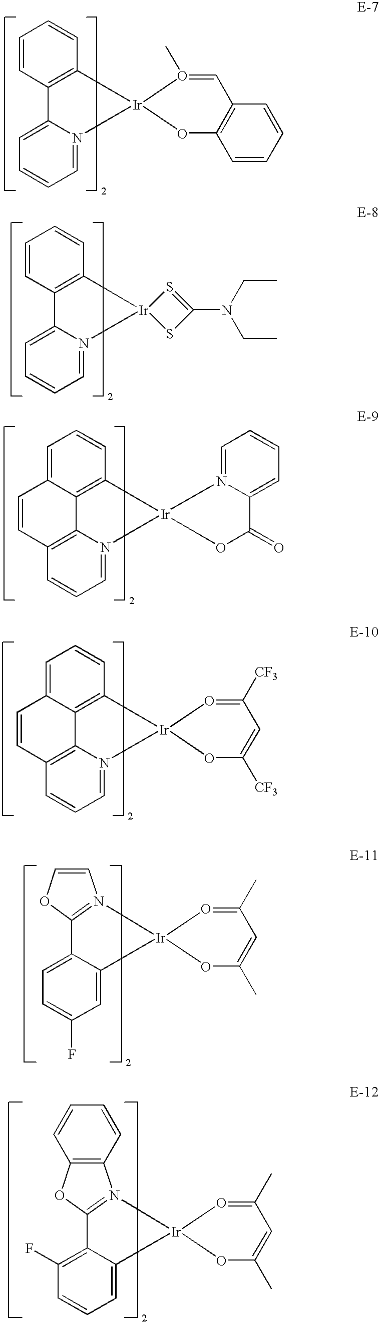

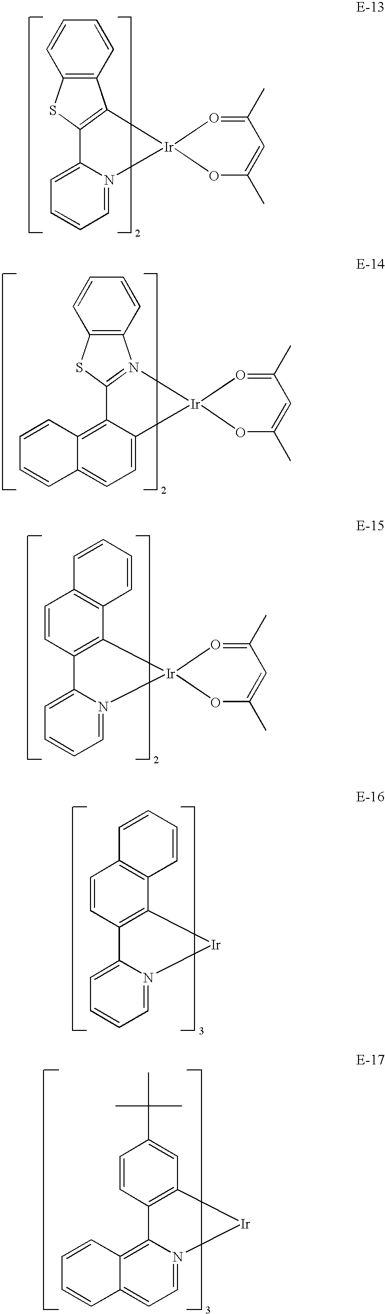

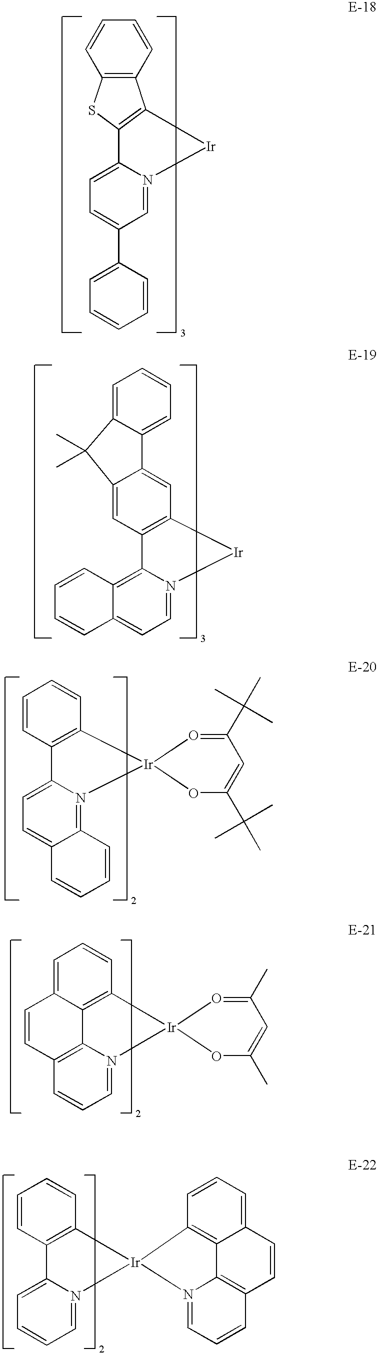

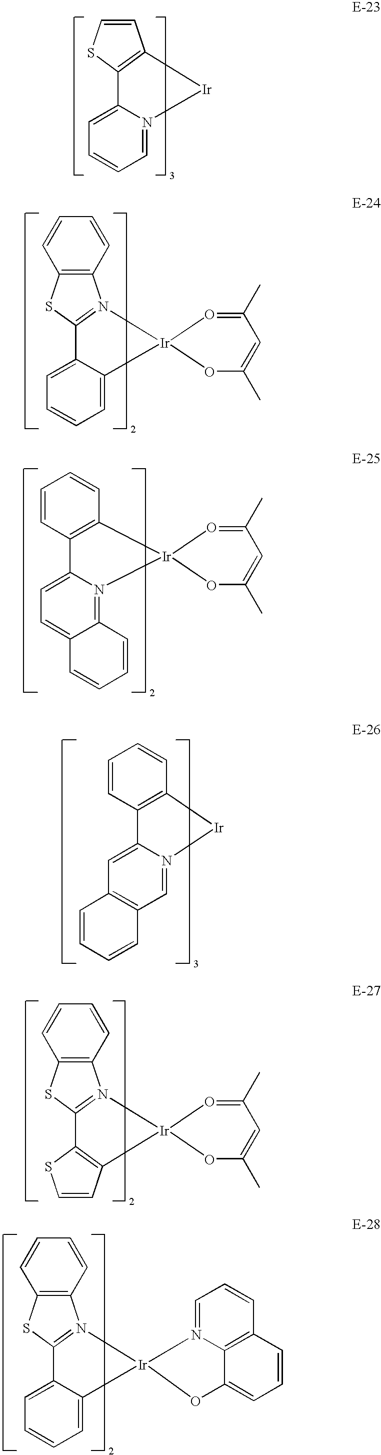

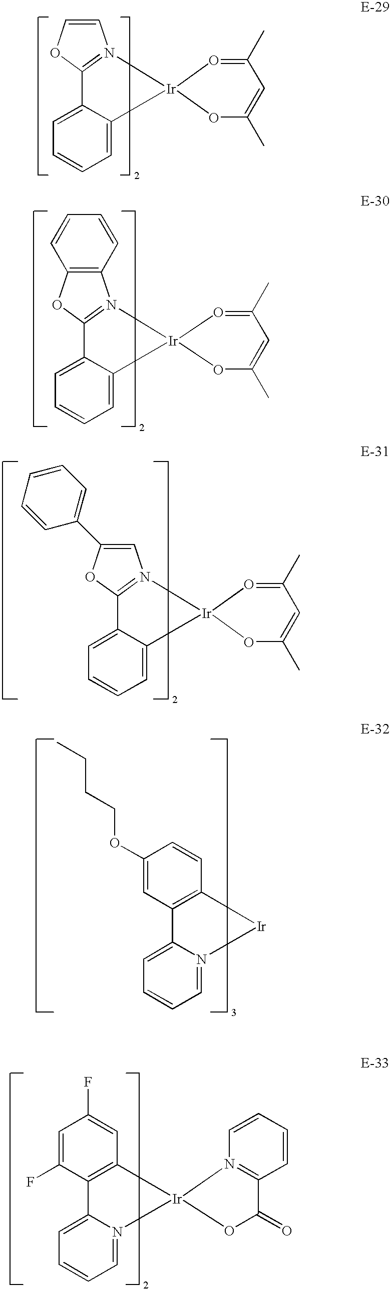

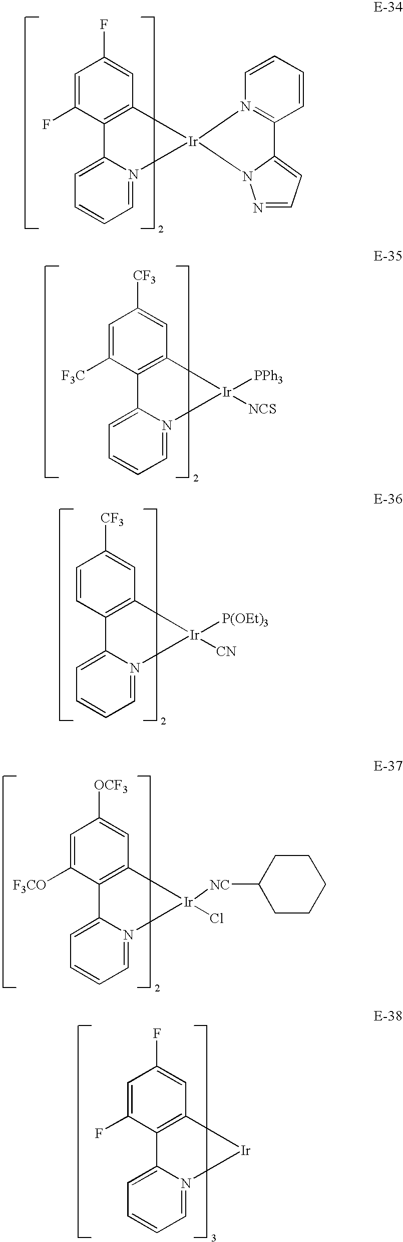

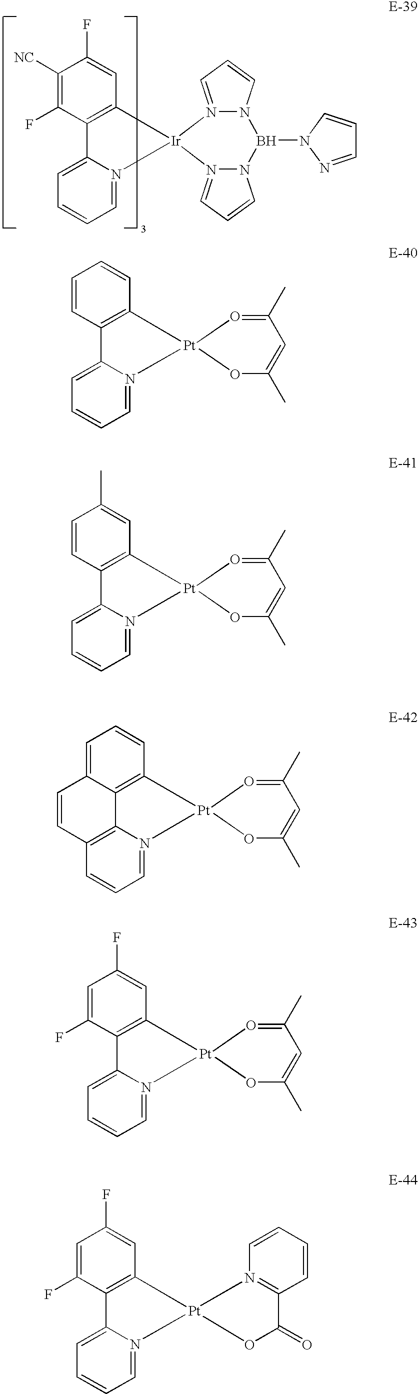

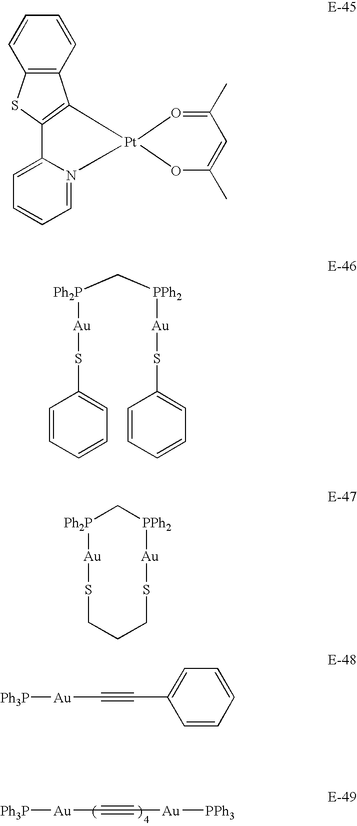

In the above formulae (E-35), and (E-46) to (E-49), Ph represents phenyl group.

Examples of the polymerizable substituent of these phosphorescent compounds include, for example, vinyl group; acrylate group; methacrylate group; an urethane (meth)acrylate group such as methacryloyloxyethylcarbamate group; styryl group and its derivatives; vinylamide group and its derivatives.

Among these, vinyl group, methacrylate group, and styryl group or its derivatives are preferable. These substituents may be bonded to the metal complex through an organic group that has from 1 to 20 carbon atoms and may contain a heteroatom.

Among these compounds, the compounds represented by the above formulae (E-2), (E-17), (E-32), and (E-33) are preferable, because the compounds have a high affinity to a solvent and are thus hardly precipitated or flocculated in a solution, and therefore provide an organic EL emission layer having a uniform thickness.

Examples of the above-mentioned carrier-transporting compound having a polymerizable substituent include a compound that is obtained by substituting a polymerizable substituent for one or more hydrogen atoms contained in an organic compound that has either one or both of hole-transporting and electron-transporting properties. Typical examples of the compound include the compounds represented by the following formulae (E-50) to (E-67).

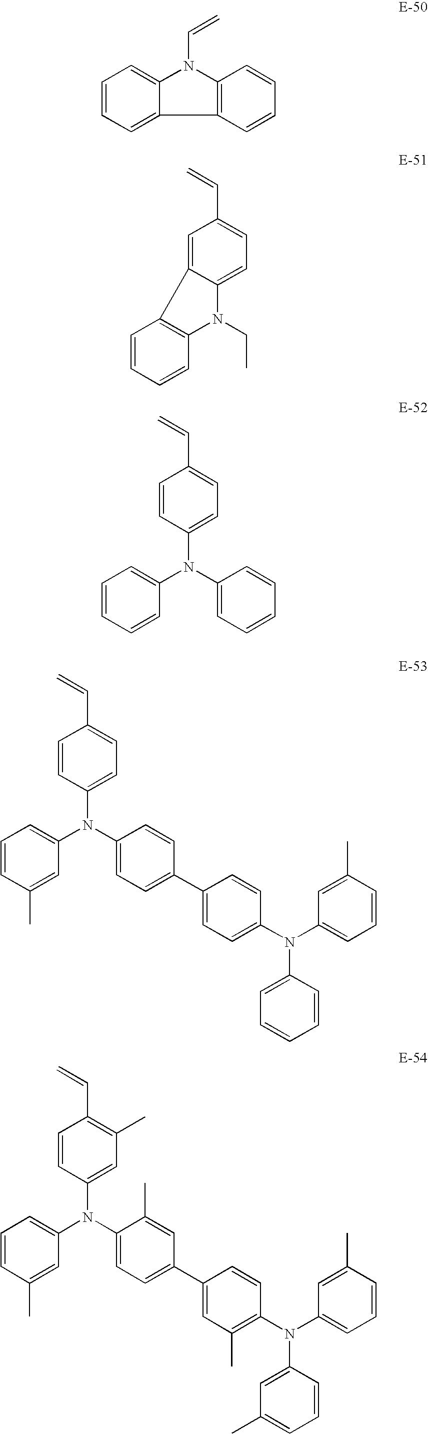

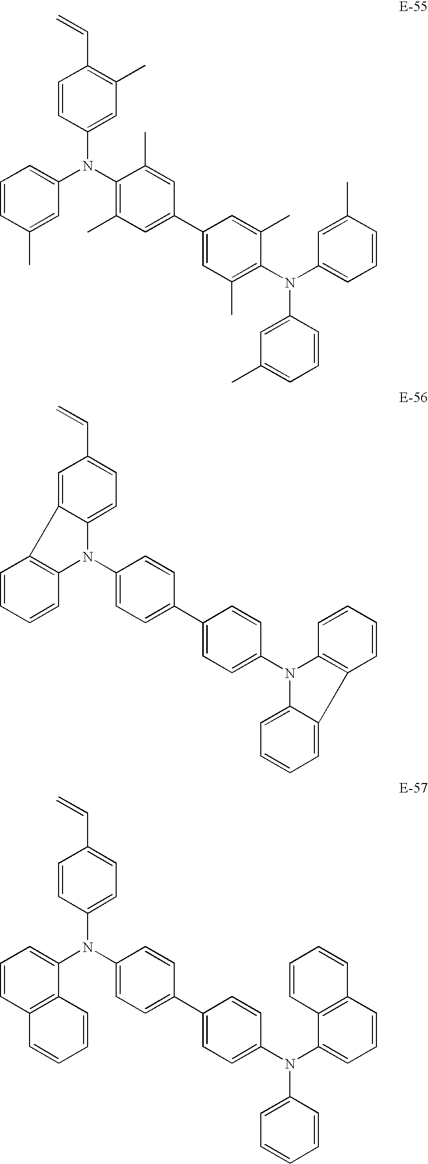

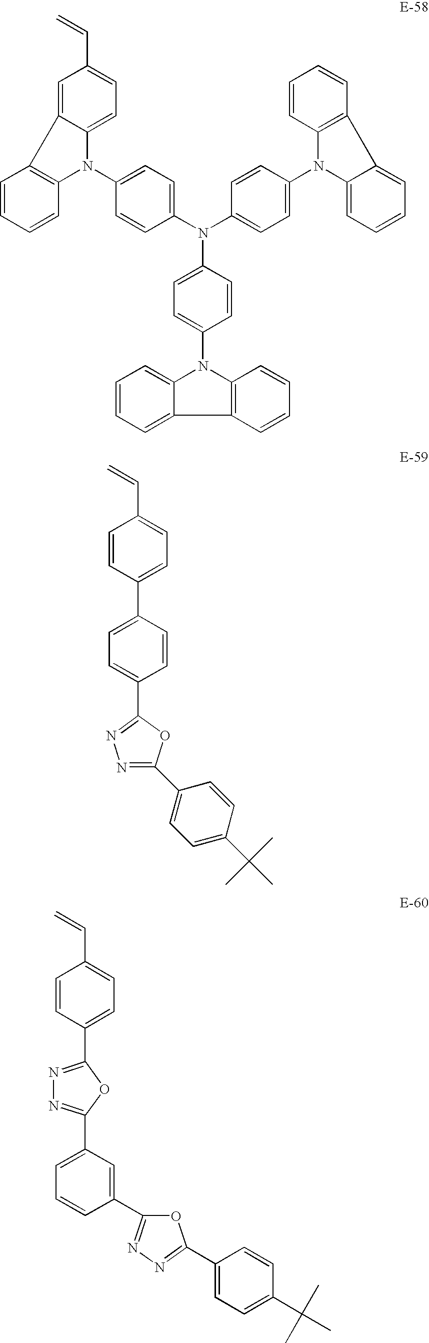

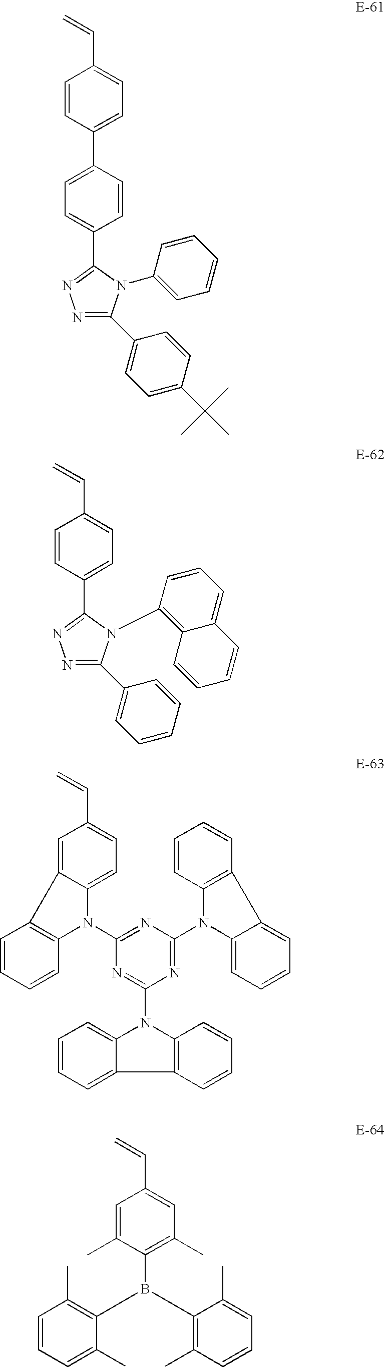

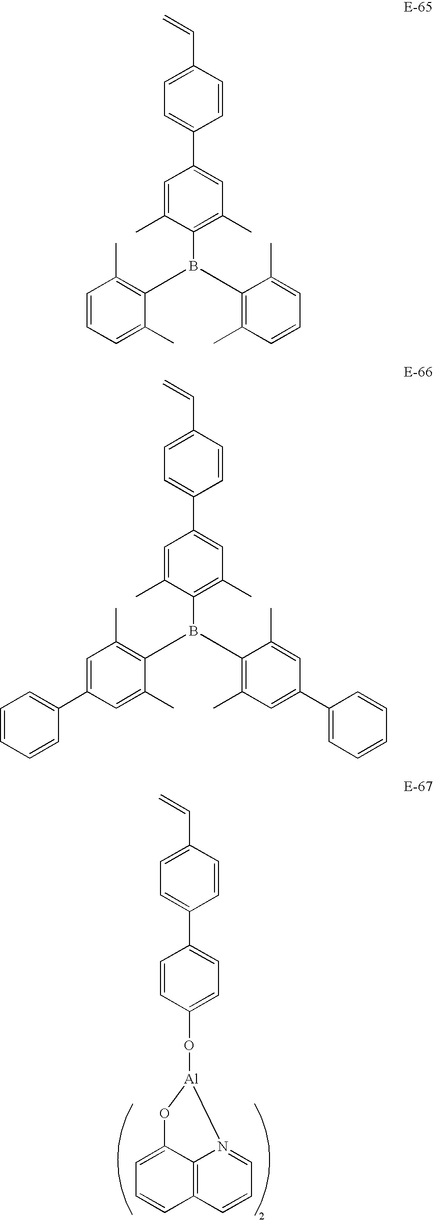

The carrier-transporting compounds exemplified above have vinyl group as a polymerizable substituent, but the compounds may be compounds obtained by substituting the vinyl group with a polymerizable substituent such as acrylate group; methacrylate group; an urethane (meth)acrylate group such as methacryloyloxyethylcarbamate; styryl group and its derivatives; and vinylamide group and its derivatives. Further, these polymerizable substituents may be bonded through an organic group that has from 1 to 20 carbon atoms and may contain a heteroatom.

The method of polymerization of the phosphorescent compound having a polymerizable substituent and the carrier-transporting compound having a polymerizing group may be any method of radical polymerization, cation polymerization, anion polymerization, and addition polymerization, but radical polymerization is preferable. Also, the resulting polymer has a weight average molecular weight of preferably from 1,000 to 2,000,000, and more preferably from 5,000 to 1,000,000. The molecular weight is measured using GPC (gel permeation chromatography) and is represented in terms of polystyrene.

The phosphorescent polymer compound may be prepared by copolymerizing one kind of phosphorescent compound and one kind of carrier-transporting compound; one kind of phosphorescent compound and two or more kinds of carrier-transporting compounds; or two or more kinds of phosphorescent compounds and a carrier-transporting compound.

The monomers of the phosphorescent polymer compound may be polymerized in any arrangement to form a random copolymer, a block copolymer, or an alternating copolymer. When m is the number of the repeating units of the phosphorescent compound structure, and n is the number of the repeating units of the carrier-transporting compound structure (where m and n each represent an integer equal to or larger than 1), the ratio of the number of repeating units of the phosphorescent compound structure to the total number of the repeating units, that is, m/(m+n) is preferably from 0.001 to 0.5, and more preferably from 0.001 to 0.2.

The specific examples of the phosphorescent polymer compound and synthetic method thereof are disclosed in, for example, Japanese Patent Laid-Open Publication No. 2003-342325, Japanese Patent Laid-Open Publication No. 2003-119179, Japanese Patent Laid-Open Publication No. 2003-113246, Japanese Patent Laid-Open Publication No. 2003-206320, Japanese Patent Laid-Open Publication No. 2003-147021, Japanese Patent Laid-Open Publication No. 2003-171391, Japanese Patent Laid-Open Publication No. 2004-346312, and Japanese Patent Laid-Open Publication No. 2005-97589.

The light-emitting layer of the organic EL element used in the present invention preferably contains the above-mentioned phosphorescent compound. In addition, the light-emitting layer may contain a hole-transporting compound or an electron-transporting compound so as to supplement the carrier-transporting performance of the light-emitting layer.

Examples of the hole-transporting compound used for this purpose include, for example, a low-molecular-weight triphenylamine derivative such as TPD (N,N′-dimethyl-N,N′-(3-methylphenyl)-1,1′-biphenyl-4,4′-diamine), α-NPD (4,4′-bis[N-(1-naphthyl)-N-phenylamino]biphenyl), and m-MTDATA (4,4′, 4″-tris(3-methylphenylphenylamino) triphenylamine); polyvinylcarbazole; and a compound that is obtained by polymerizing the above triphenylamine derivative after a polymerizable functional group is incorporated into the derivative, for example, a polymer compound having a triphenylamine skeleton disclosed in Japanese Patent Laid-Open Publication No. H08-157575, polyparaphenylenevinylene, and polydialkylfluorene. As the electron-transporting compound, there may be used a low molecular-weight material such as a quinolinol derivative metal complex such as Alq3 (aluminum trisquinolinolate), an oxadiazole derivative, a triazole derivative, an imidazole derivative, a triazine derivative, and a triarylborane derivative; and a compound that is obtained by polymerizing the above low molecular-weight electron-transporting compound after a polymerizable functional group is incorporated into the low molecular-weight electron-transporting compound, for example, a known electron-transporting compound such as polyPBD disclosed in Japanese Patent Laid-Open Publication No. H10-1665.

### 6. Method for Forming Organic EL Compound Layer

The organic EL compound layer may be formed by resistance heating evaporation, electron beam evaporation, sputtering, and coating processes such as spin coating, casting, micro-gravure coating, gravure coating, bar coating, roll coating, wire-bar coating, dip coating, spray coating, screen printing, flexo printing, offset printing and ink-jet printing.

In the case of the luminescent low molecular-weight compound, resistance heating evaporation and electron beam evaporation are mainly employed. In the case of the luminescent high-molecular-weight (polymer) compound, mainly employed are the coating processes such as spin coating, casting, micro-gravure coating, gravure coating, bar coating, roll coating, wire-bar coating, dip coating, spray coating, screen printing, flexo printing, offset printing and ink-jet printing.

### 7. Hole-Blocking Layer

A hole-blocking layer may be disposed adjacent to the cathode side of the light-emitting layer so as to prevent holes from passing through the light-emitting layer and to carry out recombination of holes and electrons efficiently in the light-emitting layer.

The hole-blocking layer may employ a compound that has a HOMO (Highest Occupied Molecular Orbital) level deeper than the luminescent compound. Examples of the compound include a triazole derivative, an oxadiazole derivative, a phenanthroline derivative and an aluminum complex.

Further, an exciton-blocking layer may be disposed adjacent to the cathode side of the light-emitting layer so as to prevent exciton from being deactivated by the cathode metal. In this case, the organic EL element has a configuration of substrate/anode/light-emitting layer/exciton-blocking layer/cathode buffer layer/cathode, for example. The exciton-blocking layer may employ a compound that has an excited triplet energy higher than the luminescent compound. Examples of the compound include a triazole derivative, a phenanthroline derivative and an aluminum complex.

### 8. Cathode Buffer Layer

As shown in FIG. 1, the display device of the present invention has the cathode buffer layer 4 between the cathode 5 described later and the organic EL compound layer 3 adjacent to the cathode 5 so as to increase the electron injection efficiency by lowering the barrier for the electron injection from the cathode 5 to the organic EL compound layer 3, and to display the predetermined pattern on the display screen (surface of the transparent substrate 1) of the display device. The cathode buffer layer may employ a metal, a metal oxide, or a metal fluoride that has a work function lower than the cathode. Examples of the metal oxide include oxides of Li, Na, K, Cs, Rb, Ca, Ba, or Sr. Examples of the metal fluoride include fluorides of Li, Na, K, Cs, or Rb.

In the display device of the present invention, the cathode buffer layer is formed, namely, patterned in a similar form to the predetermined pattern that is displayed on the display screen (transparent substrate surface) of the organic EL element. The predetermined pattern may be a letter or a figure.

Examples of the metal that has a low work function and is usable for the cathode buffer layer include alkali metals (Na, K, Rb, and Cs), alkaline earth metals (Sr, Ba, Ca, and Mg), rare earth metals (Pr, Sm, Eu, and Yb), and the like.

Any alloy or metal compound may be used as long as they have a lower work function than the cathode.

The method of producing the display device displaying a predetermined pattern according to the present invention includes the steps of:

forming the cathode buffer layer patterned in an almost similar form to the predetermined pattern on the surface of the organic EL compound layer; and

forming a cathode on the exposed surface of the organic electroluminescent compound layer and on the surface of the cathode buffer layer.

The organic EL compound layer etc. may be formed by conventional methods.

The method of forming the cathode buffer layer may be deposition or sputtering. The thickness of the cathode buffer layer is preferably from 0.05 nm to 50 nm, more preferably from 0.1 nm to 20 nm, and still more preferably from 0.5 nm to 10 nm.

In the step of forming the cathode buffer layer, a material for forming the cathode buffer layer may be deposited on the organic electroluminescent compound layer through a mask having an opening that is patterned in an almost similar form to the predetermined pattern.

In order to form the cathode buffer layer in an almost similar pattern to the predetermined pattern that is displayed by the display device of the present invention, the material forming the cathode buffer layer may be deposited on the organic EL compound layer using a mask having an opening (through this opening) that is patterned in an almost similar form to the predetermined pattern in the step of forming the cathode buffer layer.

The mask may contact directly the light-emitting layer when the material is deposited, but it is desirable that the mask be separated from the light-emitting layer to some extent (for example, about 200 μm) so as to prevent the light-emitting layer from being damaged.

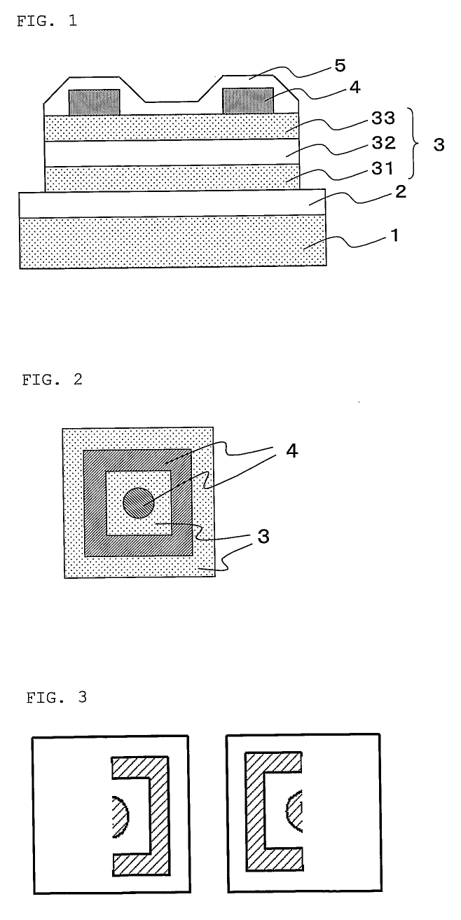

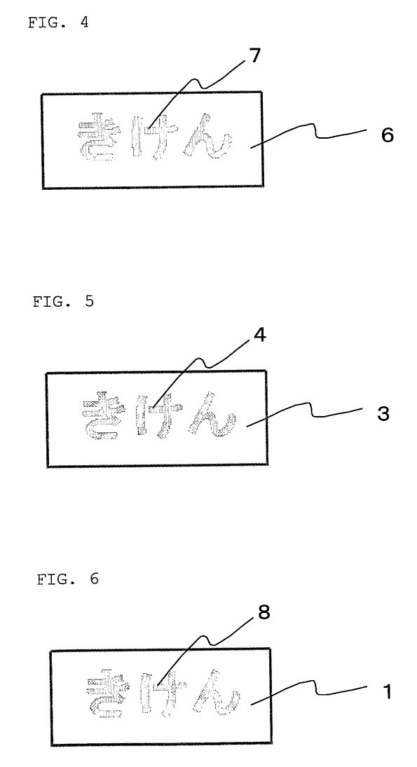

Also, the cathode buffer layer may be deposited in two or more steps using two or more kinds of masks as shown in FIG. 3. In this way, it is possible to form even the pattern as shown in FIG. 2 that cannot be formed using one mask in a single step.

Further, the cathode buffer layer may be formed as a mixture of the above-mentioned material having a low work function and an electron-transporting compound. As this electron-transporting compound, there may be used the organic compound that is used for the above-mentioned electron-transporting layer. In this case, the cathode buffer layer can be formed by a co-deposition method.

In the case where the cathode buffer layer can be formed by coating a solution, the aforementioned methods such as spin coating, dip coating, ink-jet printing, printing, spraying coating and dispenser method may be applied. In this case, the thickness of the cathode buffer layer is preferably from 0.1 nm to 100 nm, more preferably from 0.5 nm to 50 nm, and still more preferably from 1 nm to 20 nm.

In order to form the cathode buffer layer having a predetermined pattern by coating a solution that contains the material for the cathode buffer layer, the solution is coated not on the entire surface of the light-emitting layer, but is coated in a desired pattern.

The display device according to the present invention has the cathode buffer layer that is patterned in a similar form to the predetermined pattern to be displayed as desired, so that the light-emitting layer is not required to emit light from the entire surface thereof. Light is emitted only from the area between the anode and the patterned cathode buffer layer, where the electron injection barrier from the cathode 5 to the organic EL compound layer 3 is lowered by an action of the cathode buffer layer, and thus the electron injection efficiency is increased. In this way, a predetermined pattern is displayed on the display device of the present invention having the organic EL element.

On the other hand, the conventional organic EL element as shown in FIG. 11 has a cathode buffer layer 4 that is disposed on the entire surface of the organic EL compound layer 3. Therefore, the light-emitting layer emits light from the entire area thereof, and thus a display device equipped with the conventional organic EL element provided with the cathode buffer layer 4 cannot display a predetermined pattern.

In this way, the display device of the present invention can display a predetermined pattern by a simple structure without lowering the electrical power efficiency.

### 9. Cathode

As the cathode material for the organic EL element used in the present invention, there may be exemplified known cathode materials such as Al, an MgAg alloy, and an alloy of Al and an alkali metal (for example, AlLi and AlCa), which have a low work function and are chemically stable. In view of chemical stability, it is desirable that the work function is 2.9 eV or more. These cathode materials are formed into a film by resistance heating evaporation, electron beam evaporation, sputtering, ion plating, and the like. The thickness of the cathode is preferably from 10 nm to 1 μm, and more preferably from 50 nm to 500 nm.

In the case where the cathode buffer layer is formed by using a mask, the cathode is formed after the mask is removed in the cathode forming step.

The cathode is formed to cover not only the surface of the cathode buffer layer, but also the cathode buffer layer and the entire portion of the organic EL compound layer that is not covered with the cathode buffer layer and exposed. By forming the cathode in this way, the entire surface of the organic EL element can serves as a mirror when the organic EL element is not lighted.

### 10. Sealing

After the cathode is formed, a protective layer may be applied to the organic EL element. In order to use the organic EL element stably for a long time, it is desirable that a protective layer and/or cover be provided so as to protect the element from the outside. Polymer compounds, metal oxides, metal fluorides, metal borates and the like may be used for the protective layer. A glass plate, a plastics plate having a low water permeation-treated surface, a metal, and the like may be used for the protective cover. The protective cover is preferably attached to the element substrate with the help of a thermo-setting resin or a photo-curing resin so as to seal the element. It is easy to prevent the element from being damaged when a room is kept by using a spacer. The oxidation of the cathode may be prevented by filling the room with an inert gas such as nitrogen and argon. Further, the damage of the element caused by water adsorbed during the production steps may be easily prevented by putting a desiccant such as barium oxide in the room. It is desirable to take one or more of these measures.

### 11. Substrate Type

As the substrate of the organic EL element used in the present invention, there can be used an insulating substrate transparent to the emission wavelength of the luminescent compound made of known materials, for example, glass, transparent plastics such as PET (polyethylene terephthalate) and polycarbonate, a silicon substrate.

### Display Device

The display device of the present invention comprises the organic EL element mentioned above. The anode and the cathode are wired, and then a voltage is applied across both electrodes so as to display a predetermined pattern.

As mentioned above, the display device of the present invention can display a predetermined pattern with a high electrical power efficiency, because only the area patterned in an almost similar form to the predetermined pattern, but not the entire area of the light-emitting layer, emits light by a simple structure.

### Applications

Examples of application of the display device of the present invention include a cellular phone display screen, a portable music player display screen, an in-vehicle rearview mirror, a mirror and a display device for theaters.

The display screens of the cellular phone and portable music player serve as a mirror when the screens are not lighted, and work as an information screen when the screens are lighted.

The in-vehicle rearview mirror not only works as a rearview mirror to confirm safety in the rear direction but also displays information on the upper and lower ends or left and right ends thereof without impairing the function as a rearview mirror.

### EXAMPLES

The present invention will be further described in detail with reference to the following Examples, but the present invention is not limited to those Examples.

### Preparation Example 1

### Preparation of Luminescent Polymer Compound

The following monomers having a vinylstyryl group, that is, an iridium complex (a compound represented by the formula E-2) having a polymerizable substituent, a hole-transporting compound (a compound represented by the formula E-46), and an electron-transporting compound (a compound represented by the formula E-59) were copolymerized to obtain a phosphorescent polymer compound. Specifically, the above monomers in a ratio of E-2:E-46:E-59=1:4:5 (in weight ratio of the monomers charged) and a polymerization initiator V-601 (Wako Pure Chemical Industries, Ltd.) were dissolved in a dehydrated toluene solution. The resulting solution was sealed under vacuum after freezing and degassing procedure, and then stirred at 70° C. for 100 hrs. After the reaction was completed, the reaction solution was added dropwise into acetone to form a precipitate, and the precipitate was then purified by repeating precipitation and purification three times by using a toluene and acetone. The acetone and toluene used here were of the high purity grade (manufactured by Wako Pure Chemical Industries, Ltd.) and were distilled before use. The solvent recovered after the repeating precipitation and purification was analyzed by high performance liquid chromatography. Any substance having absorption at 400 nm or above was confirmed not to be detected in the solvent after the third precipitation and purification. In this way, impurities in the phosphorescent polymer compound were removed. Subsequently, the phosphorescent polymer compound was vacuum-dried at room temperature for two days. The purity of the phosphorescent polymer compound obtained was confirmed to be over 99.9% by high performance liquid chromatography at a detection wavelength of 254 nm.

The phosphorescent polymer compound thus prepared was dissolved in toluene in a nitrogen atmosphere to obtain a solution (A).

### Example 1

On a glass substrate 100 mm square in size having an ITO (indium tin oxide) electrode (anode) on the surface thereof, poly(3,4-ethylenedioxythiophene)/polystyrene sulfonic acid was spin-coated at a revolution of 3500 rpm and a coating time of 40 sec. The resulting coating was dried under vacuum in a vacuum dryer at 60° C. for 2 hrs to obtain an anode buffer layer. The thickness of the anode buffer layer was about 50 nm.

Subsequently, the solution (A) was spin-coated at a revolution of 3000 rpm and a spinning time of 30 sec on the anode buffer layer. The coating was dried under reduced pressure in a vacuum drier in the dark at 100° C. for 1 hr. The thickness of the resulting organic EL compound layer 3 (light-emitting layer 32) was 80 nm.

Then, a 0.5 mm thick stainless steel plate 6 (made of sus430) having an opening part 7 that was patterned in [symbol] (“dangerous”)

by punching out was placed on the substrate, on the side of organic EL compound layer 3 as shown in FIG. 4. The assembly was placed in a vacuum deposition chamber in a manner that the stainless steel plate 6 faced toward the evaporation source.

Calcium was deposited to a thickness of about 10 nm by resistance heating evaporation so as to form the cathode buffer layer 4 having a pattern of letters [symbol] (“dangerous”)

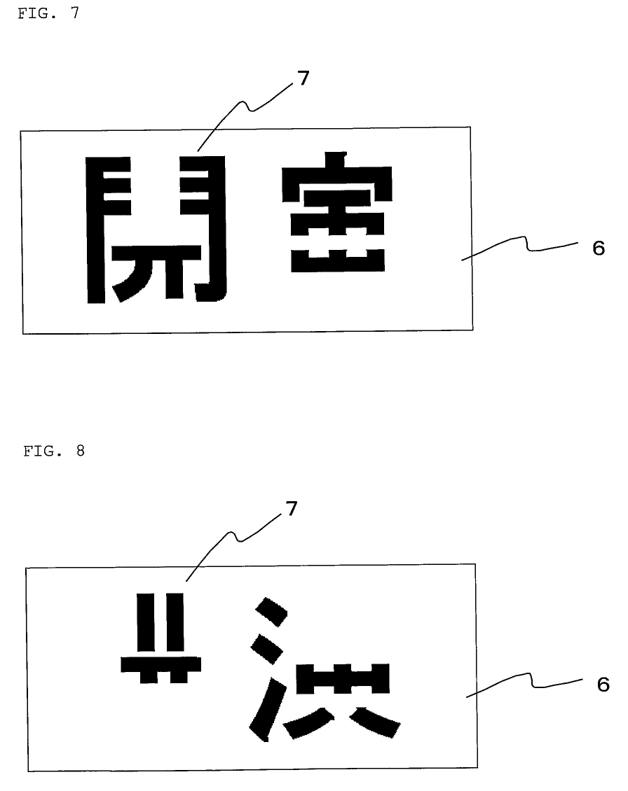

on the organic EL compound layer 3 as shown in FIG. 5.

After the stainless steel plate 6 was removed from the assembly, the cathode 5 was formed by depositing aluminum to a thickness of about 100 nm on the organic EL compound layer 3 having the cathode buffer layer 4 formed thereon, so that an organic EL element was obtained.

A glass sealing cap was attached to the organic EL element thus prepared with the help of a thermo-setting epoxy adhesive in a usual manner. Further, electrical wires and a power source were attached to obtain an evacuation sign.

The evacuation sign looks like a mirror because of the aluminum used in the cathode when no voltage is applied. When a voltage of 15 V was applied to the light, the predetermined pattern (letters) 8 of [symbol] (“dangerous”)

as shown in FIG. 6 was displayed by luminescence.

### Example 2

A display device for theaters displaying the letters of [symbol] (“opening curtain”)

was prepared in a similar manner to Example 1, except that the step of forming the cathode buffer layer 4 was changed as follows.

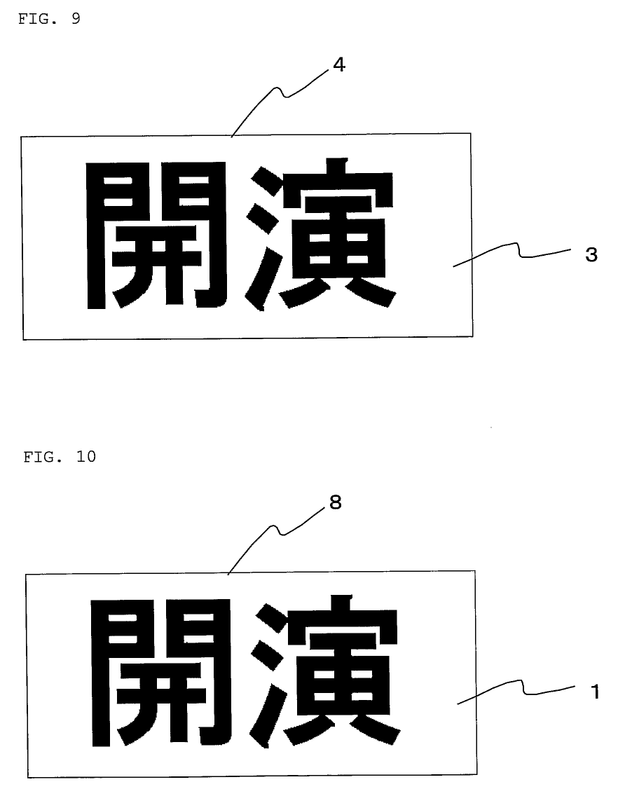

On forming the cathode buffer 4, firstly a patterned calcium layer was formed by using a 0.5 mm thick stainless steel plate 6 having an opening 7 formed by punching out as shown in FIG. 7. Then, by using a 0.5 mm thick stainless steel plate 6 having an opening 7 formed by punching out as shown in FIG. 8, a calcium layer patterned in the form of the letters [symbol] (“opening curtain”)

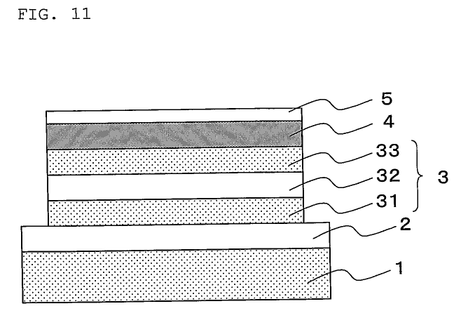

as shown in FIG. 9, that is the cathode buffer layer 4, was formed on the organic EL compound layer 3.

The letters [symbol] (“opening curtain”)

were not recognized when no voltage was applied to the display device for theaters. On the other hand, by applying a voltage, the predetermined pattern (letters) 8 of [symbol] (“opening curtain”)
was recognized as shown in FIG. 10.

A panel equipped with the above display device is, for example, installed in a theater and can be used to give notice of opening curtain to the theater attendance. The panel is lighted briefly right before opening curtain. When the panel is not lighted, the attendance cannot recognize these letters and does not pay unnecessary attention. The panel also has an advantage of not impairing the interior appearance of the theater.

### Example 3

An alarm display device displaying the predetermined pattern (letters) of [symbol] (“fire breaking”)

was prepared in a similar manner to Example 2, except that the form of the mask used for forming the cathode buffer layer 4 was changed.

When the display device was not lighted, the letters of [symbol] (“fire breaking”)

were not recognized, and the device maintained a mirror-like appearance because the aluminum used for the cathode provided a metallic total reflection. The display device can serves as a mirror, so that the display device can be installed in a bathroom in place of an existing mirror, for example. When no voltage is applied, the display device works similar to conventional mirrors. On fire emergency, the letters of [symbol] (“fire breaking”)
are displayed on the mirror panel by applying voltage to the panel. In this way, the display device works as an emergency alarm device that informs fire breaking.

The display device has a desirable appearance, because the device normally serves as a mirror.

1. A display device displaying a predetermined pattern comprising an organic electroluminescence element comprising a transparent anode, an organic electroluminescent compound layer, a cathode buffer layer patterned in an almost similar form to the predetermined pattern and a cathode laminated in this order on a transparent insulating substrate.

2. The display device according to claim 1, wherein the organic electroluminescent compound layer comprises a phosphorescent compound.

3. The display device according to claim 2, wherein the phosphorescent compound is an iridium complex.

4. The display device according to claim 2, wherein the phosphorescent compound is a phosphorescent polymer compound.

5. The display device according to claim 4, wherein the phosphorescent polymer compound is a phosphorescent non-conjugated polymer compound.

6. The display device according to claim 5, wherein the phosphorescent non-conjugated polymer compound is a polymer compound having a structural unit derived from an iridium complex compound that is obtained by substituting a polymerizable substituent for one or more hydrogen atoms contained in a compound represented by the following formula (X-1), 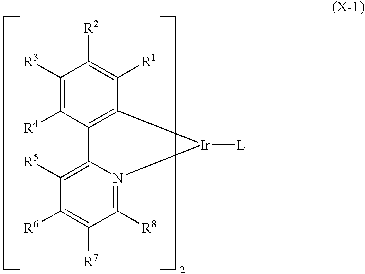
in the formula (X-1), R¹ to R⁸ each represent independently an atom or a substituent selected from the group consisting of a hydrogen atom, a halogen atom, a cyano group, an alkyl group having from 1 to 10 carbon atoms, an aryl group having from 6 to 10 carbon atoms, an amino group optionally substituted with an alkyl group having from 1 to 10 carbon atoms, an alkoxy group having from 1 to 10 carbon atoms, and a silyl group; R¹ and R², R² and R³, R³ and R⁴, R⁴ and R⁵, R⁵ and R⁶, R⁶ and R⁷, or R⁷ and R⁸ may be bonded together to form a condensed ring; and L is a bidentate ligand selected from the group consisting of the following formulae (X-2) to (X-4), 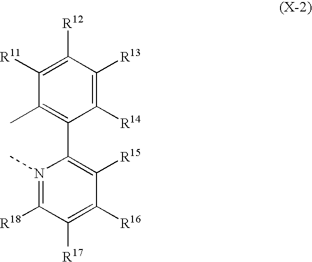
in the formula (X-2), R¹¹ to R¹⁸ are the same as R¹ to R⁸ in the formula (X-1), 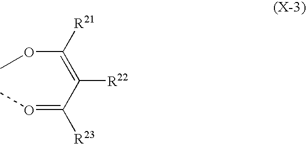
in the formula (X-3), R²¹ to R²³ each represent independently an atom or a substituent selected from the group consisting of a hydrogen atom, a cyano group, an alkyl group having from 1 to 10 carbon atoms, an aryl group having from 6 to 10 carbon atoms, an amino group optionally substituted with an alkyl group having from 1 to 10 carbon atoms, an alkoxy group having from 1 to 10 carbon atoms, and a silyl group; and R²¹ and R²², or R²² and R²³ may be bonded together to form a condensed ring, 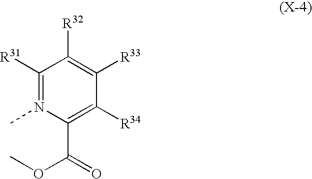
in the formula (X-4), R³¹ to R³⁴ each represent independently an atom or a substituent selected from the group consisting of a hydrogen atom, a cyano group, an alkyl group having from 1 to 10 carbon atoms, an aryl group having from 6 to 10 carbon atoms, an amino group optionally substituted with an alkyl group having from 1 to 10 carbon atoms, an alkoxy group having from 1 to 10 carbon atoms, and a silyl group; and R³¹ and R³², R³² and R³³, or R³³ and R³⁴ may be bonded together and form a condensed ring.

7. The display device according to claim 5, wherein the phosphorescent non-conjugated polymer compound is a polymer compound having a structural unit derived from an iridium complex compound that is obtained by substituting a polymerizable substituent for one or more hydrogen atoms contained in at least one kind of compound selected from the group consisting of compounds represented by the following formulae (E-2), (E-17), (E-32), and (E-33),

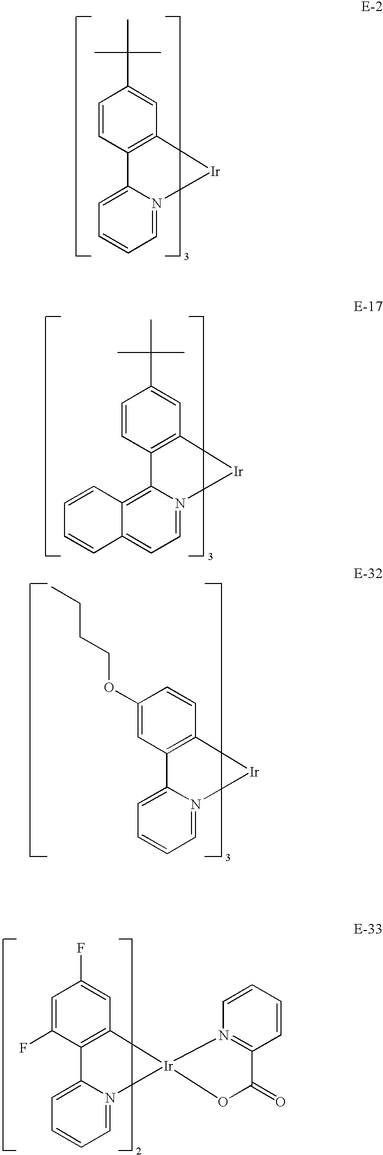

8. A method of producing a display device displaying a predetermined pattern comprising steps of:
forming a cathode buffer layer patterned in an almost similar form to the predetermined pattern on the surface of an organic electroluminescent compound layer; and
forming a cathode on the surface of the cathode buffer layer.

9. The method of producing a display device according to claim 8, comprising,
in the step of forming the cathode buffer layer, depositing a material for forming the cathode buffer layer on the organic electroluminescent compound layer through a mask having an opening that is patterned in an almost similar form to the predetermined pattern, and
in the step of forming the cathode, subsequently forming the cathode after removing the mask.

10. A cellular phone display screen comprising the display device according to claim 1.

11. A portable music player display screen comprising the display device according to claim 1.

12. An in-vehicle rearview mirror comprising the display device according to claim 1.

13. A mirror comprising the display device according to claim 1.

14. A display device for theaters comprising the display device according to claim 1.
